(19) United States
(12) Patent Application Publication
(10) Pub. No.: US 2021/0019635 A1
(43) Pub. Date: Jan. 21, 2021

(54) GROUP SPECIFIC DECISION TREE

(71) Applicant: RAMOT AT TEL AVIV UNIVERSITY, Tel Aviv (IL)

(72) Inventors: Lior Wolf, Tel Aviv (IL); Eyal Shulman, Tel Aviv (IL)

(21) Appl. No.: 16/946,613

(22) Filed: Jun. 29, 2020

Related U.S. Application Data
(60) Provisional application No. 62/874,031, filed on Jul. 15, 2019.

(51) Int. Cl. G06N 5/00; G06F 17/18; G06F 17/16

(52) U.S. Cl. CPC G06N 5/003; G06F 17/16; G06F 17/18

(57) ABSTRACT

A method for generating a decision tree based response to a query that is related to a group of at least one user out of multiple groups of at least one users, the method may include obtaining the query; and generating the decision tree based response, wherein the generating of the decision tree based response includes applying one or more decisions of a group specific decision tree, wherein the group specific decision tree is associated with the group and is generated by applying an embedding function and regression functions on group related information, wherein the embedding function and the regression functions are learnt using information related to other groups of the multiple groups.

### CROSS REFERENCE

This application claims priority from U.S. provisional patent Ser. No. 62/874,031 filing date Jul. 15, 2019 which is incorporated herein by reference.

### INTRODUCTION

There is a growing demand for artificial intelligence (AI) systems that justify their decisions. This is especially the case in recommendation systems (RS), for which users can feel harmed or offended by the provided recommendations. Unfortunately, most RS to date are uninterpretable black boxes.

Decision trees, with decision rules that are based on single attribute values, are perhaps the most explainable machine learning model in use. The explanation is given by the sequence of decisions along the path in the decision tree taken for a given input sample and each decision in the sequence is directly linked to an input feature.

In the context of RS, fitting a decision tree to predict the user's rating of a given item, based on features derived from the item's and the user's data, leads to uncompetitive performance, due to the task's inherent complexity.

### SUMMARY

There may be provided a method, system and non-transitory computer readable medium as illustrated in the specification, claims and/or drawings.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates an example of training set, a user specific decision tree, and predictions;

FIG. 2A illustrates an example of generating a node of a user specific decision tree;

FIG. 2B illustrates an example of generating and using a user specific decision tree;

FIG. 3 illustrates examples of performances;

FIG. 4 illustrates examples of performances;

FIG. 5 illustrates examples of performances;

FIG. 6A illustrates examples of performances;

FIG. 6B illustrates examples of performances;

FIG. 6C illustrates examples of performances;

FIG. 7 illustrates examples of performances;

FIG. 8 illustrates examples of performances;

FIG. 9 illustrates examples of performances;

FIG. 10 illustrates an example of a method; and

FIG. 11 illustrates an example of a method.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that can be executed by the system and should be applied mutatis mutandis to a non-transitory computer readable medium that stores instructions that once executed by a computer result in the execution of the method.

The specification may include references to a user (for example there may be provided references to a user specific decision tree). It should be noted that any reference to a user should be applied mutatis mutandis to a group that may include one or more users. The users that form a group may be grouped using any criterion and may include any number of users. For example—users may be grouped based on one or more criteria. Non-limiting examples of a criterion include location, purchase history, feedback provided by users, regions of interest, and the like.

Information about a group may be information generated by one or more users of the group (for example—decisions of the one or more users of the group, information uploaded or otherwise utilized by one or more users of the group), or information that is not generated by one or more users of the group.

There is provided a method, system and a non-transitory computer readable medium (also referred to as a solution) to various problems—such as the problem of building explainable recommendation systems that are based on a per-user decision tree, with decision rules that are based on single attribute values.

The solution builds the decision trees by applying learned regression functions to obtain the decision rules as well as the values at the leaf nodes. The regression functions may receive as input embedding of the user's training set, as well as the embedding of the samples that arrive at the current node. The embedding function and the regression functions may be learned end-to-end with a loss that includes a sparsity loss—thereby encourages the decision rules to be sparse.

The solution is of a collaborative filtering nature and may provide a direct explanation to every rating it provides. With regards to accuracy, it is competitive with other algorithms.

The solution may include employing a personalized decision tree for each user for a high-level illustration. However, learning such a tree based on the limited training data of every single user would lead to overfitting.

Therefore—the solution involves providing a regression function f that maps, at each node, the relevant training samples to a decision rule of a user specific decision tree.

A second regression function g is trained to generate values at the leaf nodes. Both regression functions f and g are trained end-to-end together with an embedding function h that represents each training sample (both the attribute vector and the provided target value) in various manners—for example as a vector. This training includes calculating a regression loss on the target values, as well as a sparsity loss that encourages the decision rules to be similar to decision stumps.

The learned functions (regression functions f and g, as well as the embedding function h) are trained for multiple users in a training set, and play the role of sharing information between users. This is a role that is played in factorization-based collaborative filtering methods by forming basis vectors for the per-user columns of the rating matrix.

Once trained, the decision rules may be transformed to decision stumps, which consistently leads to an improvement in performance. Additionally, for maximal explainability, the soft routing that is employed during training may be replaced by hard routing.

The solution may use either a fixed architecture of the user specific decision tree or a dynamic architecture of the user specific decision tree. In the fixed architecture, the user specific decision trees are full trees of a certain depth. In the dynamic architecture, the user specific decision tree growing i stopped when reaching empty nodes. On average, the dynamic trees are deeper yet employ fewer decision rules.

The inventors tested the method using various public recommendation benchmarks. It has been found that the solution is competitive with the classical methods of the field. However, the demand for having an explainable decision, especially one that is as straightforward as a decision rule, means that the method may fall slightly short in accuracy in comparison to some latest state of the art results.

The solution provides a paradigm for personalized explainable RS.

The solution includes a learning method for building interpretable recommenders that significantly outperform models with the same level of explainability.

The solution can include various model flavors with trade-offs between performance and explainability.

The solution may relay on user specific decision trees that are more accurate than (generalized) linear models.

The solution generated decisions that are based on original features (original decisions), and may train, for learning the learnt functions one or more neural networks instead of training the trees directly on the labeled set.

The solution generates user specific decision trees that may be regarded as semi-global models, which are fixed per user, in contrast to local explainable models, such as LIME which differ between individual decisions, thus failing to capture the user's model. Local models have also been criticized for not being robust to small modifications of the input.

The solution may be regarded as belonging to the family of meta-learning algorithms, and specifically to the sub-family of few-shot learning, in which sample-efficient training for a new task is performed based on observing similar tasks during training.

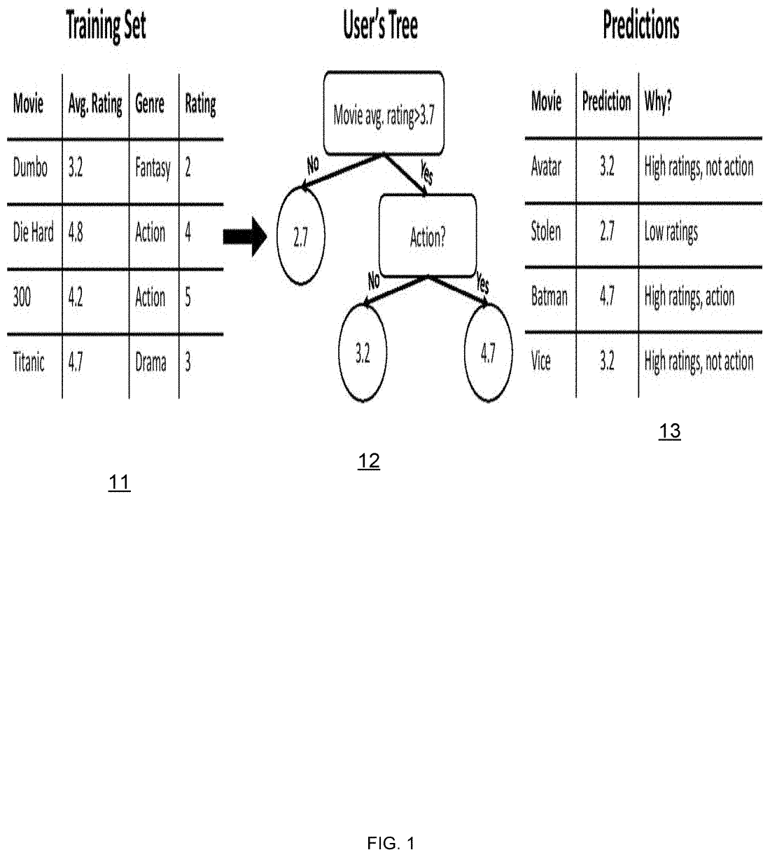

FIG. 1 illustrates an example of training set 11, a user specific decision tree 12, and predictions 13 made based on the user specific decision tree.

Let Tₕ be the hypothesis set of all decision trees of depth h with decision rules (inner nodes) of the form w^{T} x≥b for some parameters w≥0,b.

The solution may consider two types of trees, the user specific decision tree itself t, and a soft tree, which is denoted S(t), in which each sample is soft assigned by the probability σ(β(w^{T} x−b)), for some parameter β, and these probabilities are multiplied along the path from the root. The leaves contain fixed values, e.g., a score in the case of RS, or some label. In addition, for every tree t we consider a sparsified version R(t), in which the hyperplane type decision rule, based on w, is replaced by a decision stump type of rule, in which w may be replaced with a one-hot vector that corresponds to the largest value in w.

It should be noted that w hay be generated to be sparse (includes a low percent of non-zero elements) even if not a one-hot vector.

It should be noted that the user specific decision tree may be the soft tree—and the movement from one node to another is done in a probabilistic manner—in which the movement from one node to another is assigned with a certain probability.

The Inner Loop: Tree Generation for a Single User

The inner loop generates a user specific decision tree t given the samples L of a single user L={(x₁, y₁),(x₂, y₂), . . . ,(xₙ, yₙ)}⊂R^{d}ₓ×R^{d}_{y}. In other words, it acts as a tree learning algorithm, however, unlike conventional algorithms, it learns how to build suitable user specific decision trees based on users (rather user decisions) in the training set.

The learned functions h, g and f are used to build the user specific decision tree.

The embedding function h-h: X×Y→R^{d}ₕ, embeds a training sample and its label.

The first regression function f returns a decision rule given a set of embedded training samples.

The second regression function g provides a leaf value given such a set.

It should be noted that the number of functions may differ from three.

Within the inner-loop, information in L is used to build the user specific decision tree t∈Tₕ. This is done using embedding function h:

rᵢ=h(xᵢ,yᵢ) (1)

In order to represent the entire set, mean pooling may be applied—so that for i between 1 and n−r equals 1/n multiplied by a sum of rᵢ.

Given a user specific decision tree t, the solution can grow a new tree node by examining the subset of indices I⊂[1, . . . ,n] of samples in L, which are assigned to this node.

The subset I is also represented by performing mean pooling r_{I}=[1/(|I|)]*sum (for i between 1 and n) of rᵢ.

The parameters of the decision rule, concatenated to one vector [w,b,β] (recall that the third parameter is the softness parameter), are then given by:

[w,b,β]=f(r,r_{I}) (2)

Vector w may be a vector of pseudo-probabilities, by applying a softmax layer at a relevant head of a neural network that applies the first regression function f. The motivation for this decision is that we view it as a distribution over the various features. In addition, a projection by a vector w that contains multiple signs is hard to interpret. Note that the decision rule can still indicate both “larger than” and “smaller than” relations, since β can be either positive or negative.

The values at leaf nodes are assigned using the second regression function g, which seems to greatly outperform the assignment of the mean value of all samples that arrive at a leaf (denoted by subset I):

v=g(r,r_{I}) (3)

Decision nodes are added in a depth-first manner. Each sample in L is directed to only one node in each user specific decision tree level, and the time complexity of the method is O(nd), where d is the maximum depth of the user specific decision tree. For fixed architecture, the depth of the specific decision tree is a fixed depth. For dynamic user specific decision trees, nodes in which the decision rule assigns the same label to all training samples that arrive at the node are leaves.

Network Architecture

The embedding function, the first regression function and the second regression function may be implemented by one or more neural networks—or by other means. For example—the learnt functions may be implemented using three neural networks—a single neural network for each function, may be implemented by more than three neural networks, or may be implemented by less than three neural networks

The embedding function h may be implemented by a neural network—for example implemented as a four layer MLP with ReLU activations, in which each layer is of size dₕ, where dₕ is a hyperparameter of the model.

The two inputs (x,y) that represent previous user decisions are concatenated at the input layer. Both regression functions f and g implemented as two layer MLPs with a ReLU activation function, with a single hidden layer of size of 20 or 50, respectively.

The output of regression function g may goes through a logistic (sigmoid) activation function. In the recommendation benchmarks, the inventors linearly scaled the output to match the range of target values.

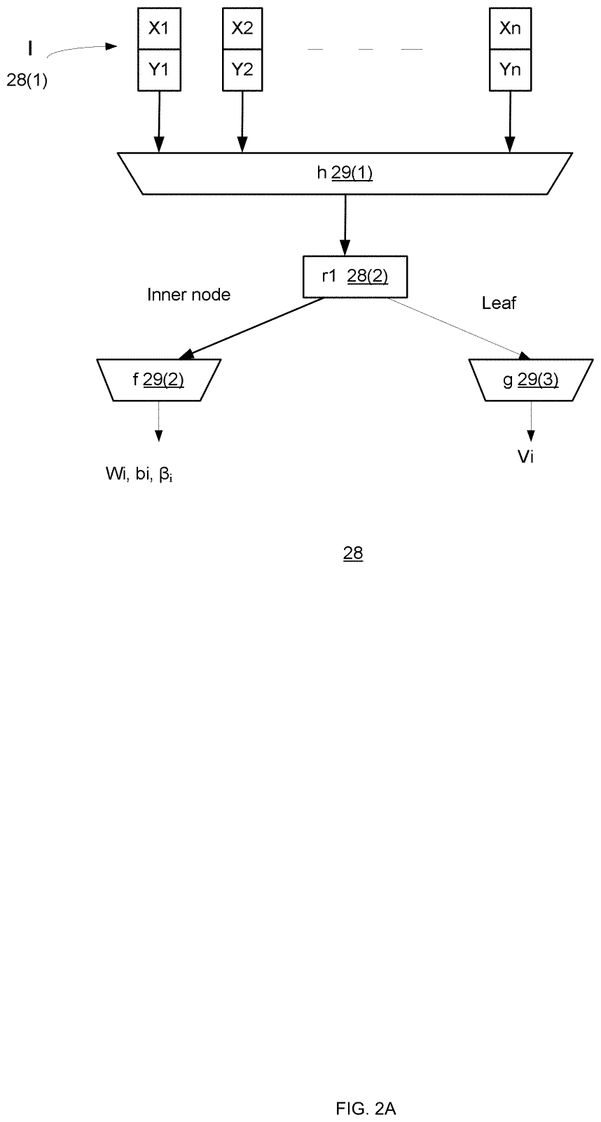

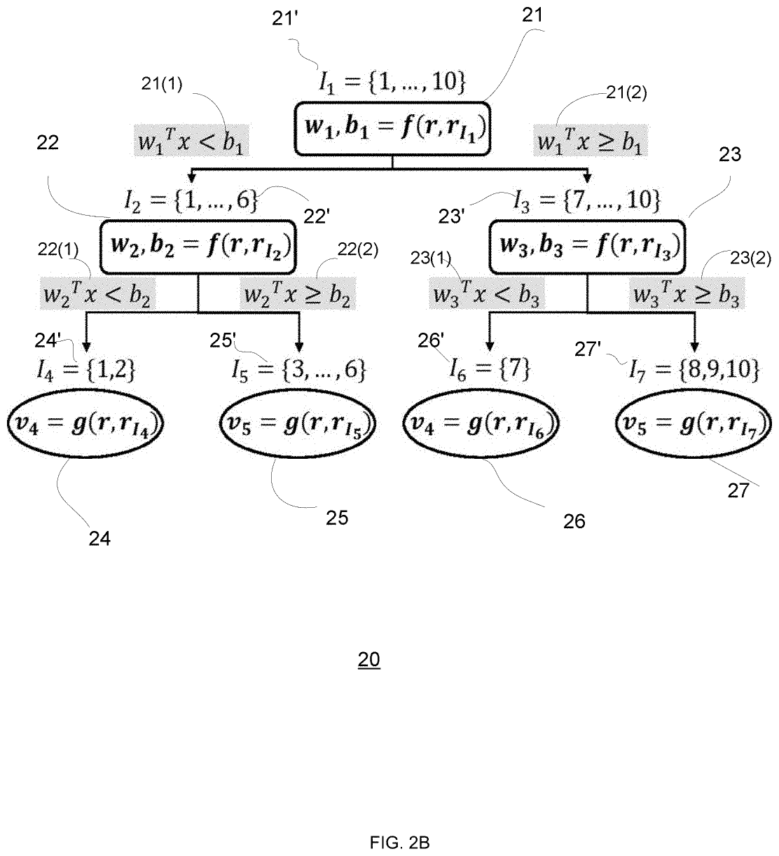

FIGS. 2A and 2B illustrate the generation of a node and a generation of a user specific decision tree 20, respectively. In FIG. 2B it is assumed that there are ten examples.

FIG. 2A illustrates that examples I (for example X1 . . . Xn and Y1 . . . Yn) are fed (when determining a root node) are fed to embedding function h 29(1) to provide r_{I1} 28(1) if not a leaf then first regression function f 29(2) is applied to provide the root decision rule (for example the values of wi, bi and βi). If leaf—apply the second regression function g 29(3) to calculate the value of the leaf node.

The first regression function f then returns the decision rule that split the examples between the root's right and left children.

For each inner node that follows the root node—the process is recursively repeated (but is applied on the examples related to that node) until reaching leaf nodes, where, using the current set embedding, g returns the leaf value v (see leaves 23 and inner nodes 22).

First and second embedding functions may be applied on both the embedding of all example and on the embeddings of the relevant group of examples.

FIG. 2B illustrates a user specific decision tree 20 that include a root node, two inner nodes 22 and 23 and four leaves 24, 25, 26 and 27.

The root node 21 is calculated by applying the embedding function and the regression functions on all ten examples (I₁=1, . . . ,10) 21′. The values of w1 and b1 are calculated based on applying first regression function on r_{I1}.

The decision rule of the root node includes jumping to the right if W₁^{T} X<b₁ (21(1)) and jumping to the left if W₁^{T} X≥b₁ (21(2)).

The jump to the right reaches an inner node that is second node 22. Second node is calculated by applying the embedding function and the first regression function on the first six examples (I₂=1, . . . ,6) 22′. The values of w2 and b2 are calculated based on applying first regression function on r_{I2}.

The decision rule of the second node includes jumping to the right if W₂^{T} X<b₂ (22(1)) and jumping to the left if W₂^{T} X≥b₂ (22(2)).

The jump to the left reaches an inner node that is third node 23. Third node is calculated by applying the embedding function and the first regression function on the last four examples (I₃=7, . . . ,10) 23′. The values of w3 and b3 are calculated based on applying first regression function on r_{B}.

The decision rule of the third node includes jumping to the right if W₃^{T} X<b₃ (23(1)) and jumping to the left if W₃^{T} X≥b₃ (22(3)).

Fourth till seventh nodes 24-27 are leaf nodes and their values are calculated by applying the embedding function on the examples associated with the leaf nodes (I4=(1,2) 24′, I5, (3,4,5,6) 25′, I6=(7) 26′, and I7=(8,9,10) 27′) respectively to provide r_{I4}, r_{I5}, r_{I6}, and r_{I7} respectively—on which the second regression function is calculated.

The following pseudo-code illustrates an example of a process (GrowTree) for generating of a user specific decision tree.

To start the initial user specific decision tree, we pass I=[n]
a. Input samples L={(xᵢ,yᵢ)}ᵢ₌₁ⁿ, [Boolean isDynamic user specific decision tree type, max depth d, I relevant indices]
b. Output a decision user specific decision tree t
c. r←[1/n]sum(for i=1 to n) of h(xᵢ, yᵢ)
d. r_{I}←[1/|I|]Σ_{i∈I}h(xᵢ, yᵢ)
   a. if d=0 return Leaf(g(r, r_{I})).
e. w, b, β←f(r, r_{I})
f. I₁←{i∈I|βw^{T} xᵢ<βb}
g. Iᵣ←{i∈I|βw^{T} xᵢ≥βb}
h. If isDynamic and (Iᵣ or I₁) are empty then return Leaf(g(r,r_{I}))
i. child₁←GrowTree(L, isDynamic, d−1, I₁)
j. childᵣ←GrowTree(L, isDynamic, d−1, Iᵣ)
k. return Node(w, b, β, child₁, childᵣ)

The Outer Loop: Training the Networks on the Set of Training Users

For training the three neural networks (one per each learnt function), the training process obtains a set of labeled training sets K={Lᵢ}_{i∈[k]}.

Each set is split into two: L′ₖ that is used to build a tree tₖ, and L″ₖ that is used to evaluate the tree and provide an error signal for training the neural networks h,f,g. Specifically, during training, the user specific decision trees may be constructed using the GrowTree process:

tₖ=GrowTree(L′ₖ,h,f,g). (4)

The tree tₖ is a function from a sample x to some leaf label v. For the purpose of computing a loss, a soft decision tree t^{soft}ₖ=S(tₖ) is generated, in which each sample x is soft-assigned to the leaves of the decision tree tₖ. Specifically, if a path to leaf node of depth δ+1 is given by a set of decision rules with parameters (wᵢ,bᵢ,βᵢ)ᵢ₌₁^{δ}, the sample is assigned to the leaf with the probability Πᵢ σ(βᵢ(wᵢ^{T} x−bᵢ)). The parameter βᵢ controls the softness of the obtained probability.

Let Z be the set of user specific decision tree leaves, where each leaf z∈Z being assigned a value v_{z}. Let t^{soft}ₖ(x,z) be the soft assignment of x into leaf z. The regression loss that is used during training is given by:

$$C ( K , h , f , g ) = {\sum }_{( {L}_{k}^{′} , {L}_{k}^{″} ) ∈ K} {\sum }_{( x , y ) ∈ {L}_{k}^{″}} {‖ y - {\sum }_{z ∈ Z} {t}_{k}^{soft} ( x , z ) {v}_{z} ‖}^{2} \qquad ( 5 )$$

Where the link between the loss and the learned networks is given by Equation 4. Other regression losses may be calculated.

In addition, it may be beneficial to encourage sparsity of each decision node in the user specific decision tree. Let W(t) be the set of hyperplanes w gathered from all nodes of user specific decision tree t, and D be the operator that returns the diagonal part of a matrix, the following sparsity loss can be defined:

$$R ( t ) = \frac{1}{\vert W ( t ) \vert} {\sum }_{w ∈ W ( t )} {\vert {ww}^{T} - D ( {ww}^{T} ) \vert}_{1} \qquad ( 6 )$$

Other sparsity losses and/or other overall losses may be calculated.

The overall loss is given by L(K,h,f,g)=C(K,h,f,g)+λΣₖ₌₁^{K} R(tₖ). The first part of the loss is the regression loss, and the second promotes the sparsity of the solution, which pushes the hyperplanes w toward the form of one-hot vectors.

Inference: Building a User Specific Decision Tree at Test Time

A user specific decision tree t may be generated given a user training set L as described in section on the inner loop.

Since the nodes perform a linear combination of the inputs, they are only partly explainable. For this reason, the user specific decision tree t may be replaced with a sparsified tree R(t), in which each node is a decision stump: for a node with parameters w,b,β, representing the decision rule β(w^{T} x−b)≥0, index i may be identified so that the index has the maximal value in w, i.e., i=argmax w[i] (recall that w is a positive vector). The decision rule of the node is replaced with the decision rule x[i]≥[b/w[i]] if β is positive, and x[i]<[b/w[i]] otherwise.

Recommendation systems naturally call for meta-learning and inter-user knowledge sharing, and due to the direct implications of the recommendations on users, transparency and interpretability are of high interest. This is also true for personalized medicine and credit decisions. However, we could not identify suitable datasets in these domains.

Semi-global explainable models, in which the user (i) has full understanding of her personalized decision rules, (ii) can validate that the model is unbiased toward protected groups, and (iii) can even edit the rules in an intuitive manner, is the right trade-off between explainability and performance. While the user specific decision tree generation networks behind the scenes are unexplainable, this is unavoidable, since any global explainable model would be inherently inaccurate due to the need to capture a diverse set of users with a model of limited capacity.

Local, Semi-Global, and Global Explainable Models

A globally interpretable model is one in which the entire logic and reasoning of the model are clear to the user. An example would be a global decision tree, in which the user can understand the logical flow that led to a certain decision. The limiting factor in such models is that the prediction capability is limited by the capacity of the model, which itself is limited by the need to remain interpretable to human users.

In contrast, local interpretability is the ability to understand the local decision. Local models such as LIME and SHAP aim to provide this ability. For every specific decision, the influence of local perturbations on the final decision is analyzed. In the case of a movie rating, the user is able to ascertain from the explanation that for a specific movie, for example, an increase in the average rating in the population would strengthen the recommendation and that if the movie was not a drama, it would not have been recommended. However, the user cannot tell if such considerations would apply to a different movie (the explanation is valid for only one movie). The user can attempt to obtain a general understanding by examining many samples, but this process is based on the user's predictive capabilities, is subjective, and more importantly, is not given by the model.

In the semi-global model that is presented in this patent application, the global model is divided into explainable parts. The user is able to grasp the model that determines the recommendations for that user, while not being able to understand how the algorithm obtained this model. Such a model is transparent to the user in the sense that the user has a complete understanding how the predicted rating of a specific item is determined and can evaluate the suitability of the model for her personal preferences. Such a model disentangles the user-specific information from that of the entire population and, therefore, does not suffer from the capacity problem as much of the global model. Unlike with local models, the user can anticipate the results of new predictions with perfect fidelity, i.e., the prediction of the model as grasped by the user completely matches that of the actual model.

Performance of kNN Trees as a Function of k

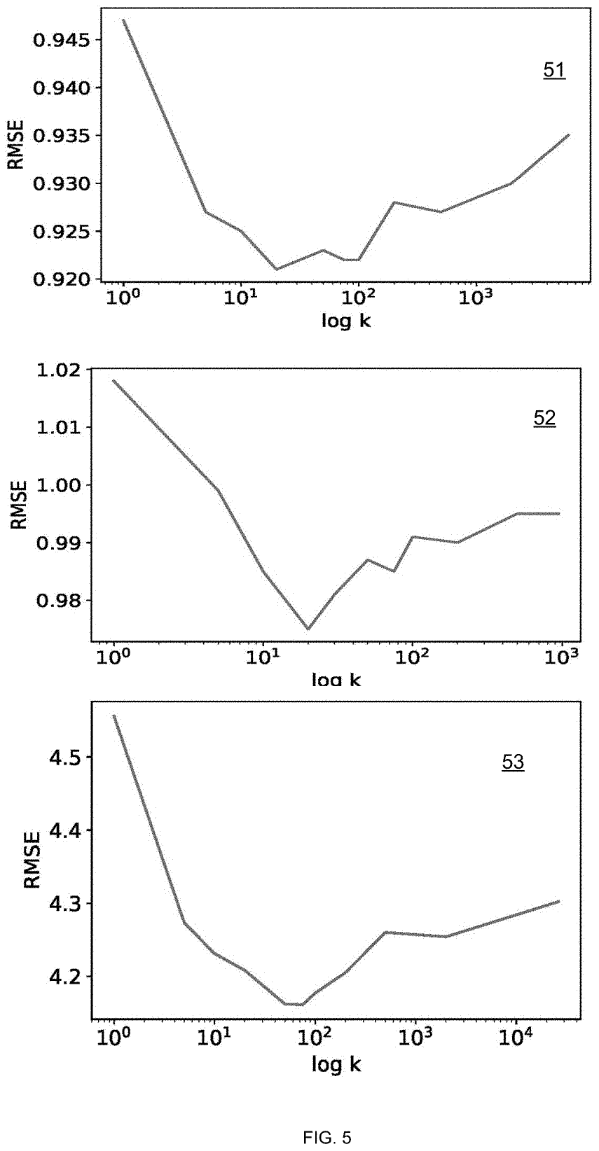

The kNN Trees are used as a baseline method that transfer knowledge from other users to augment the limited training set that is available for each user. The results of the solution are for the best k and maximal tree depth (found to be three for all three datasets) as evaluated on the test set, thus an upper bound on the solutions performance is provided for each benchmark. FIG. 5 includes graphs 51, 52 and 53 which illustrate the performance as a function of k on all three datasets.

In order to provide a fuller characterization of the performance of this baseline method, the performance of the kNN Trees algorithm are provided as a function of k on all three datasets.

FIG. 5 shows that when k=1 (Local Trees) the solution does not perform very well, but the performance improves as the single user training set is augmented with training data of its similar users. At higher k values, the performance starts to degrade until finally the algorithm uses all training data for all users (Global Tree).

Parameter Sensitivity

Sensitivity to the underlying parameters was tested: maximal depth (for a fixed architecture) and the size of the embedding dₕ. In the experiments, these were set early on to three and 512, respectively.

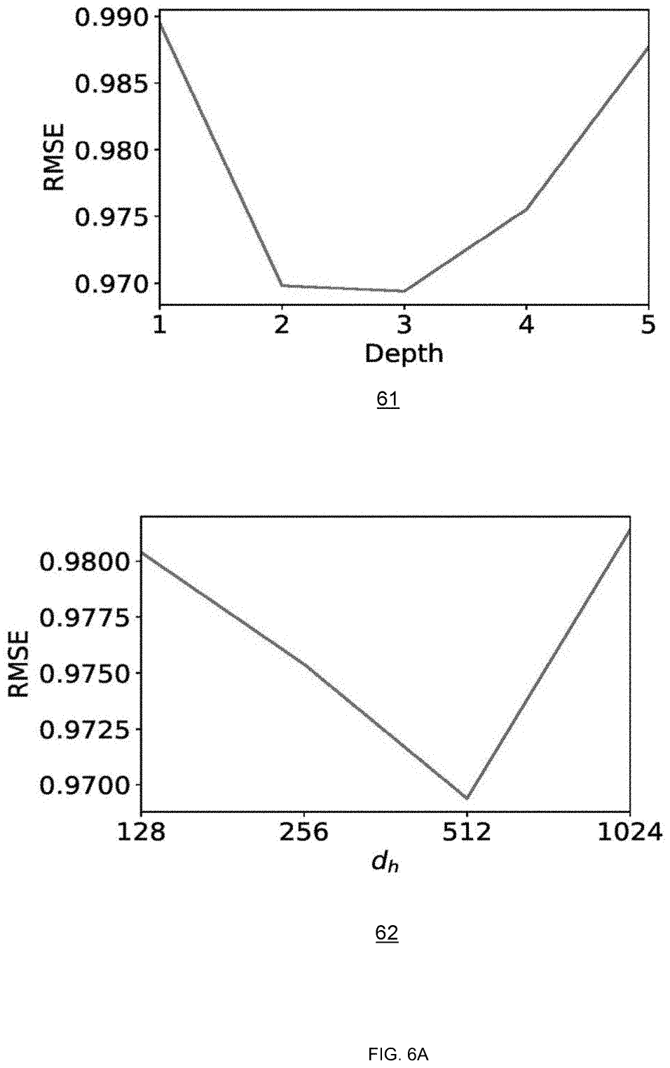

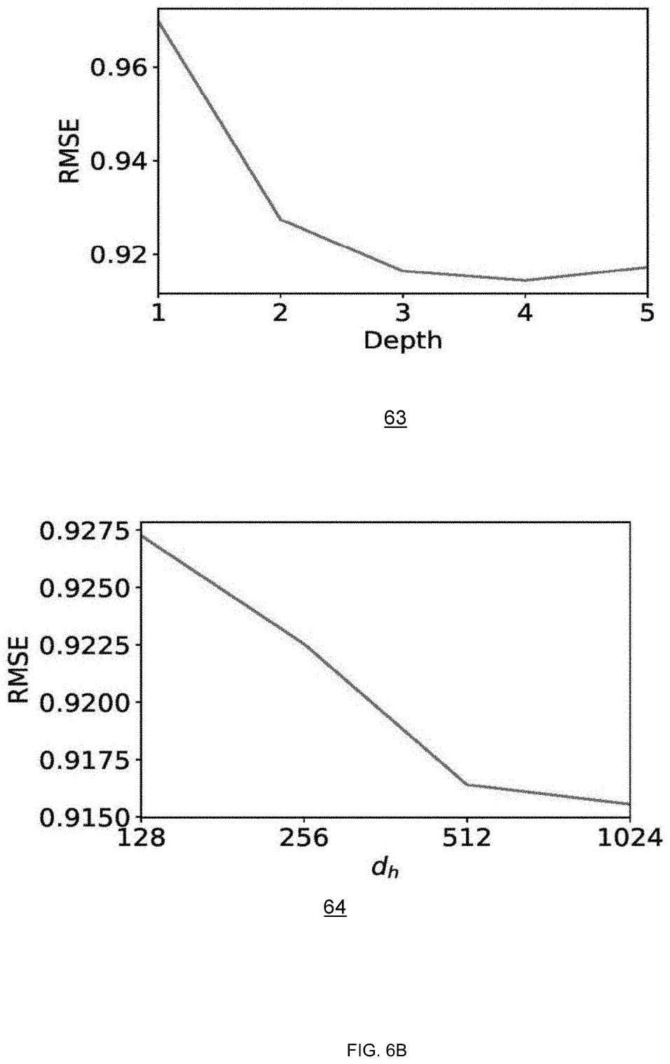

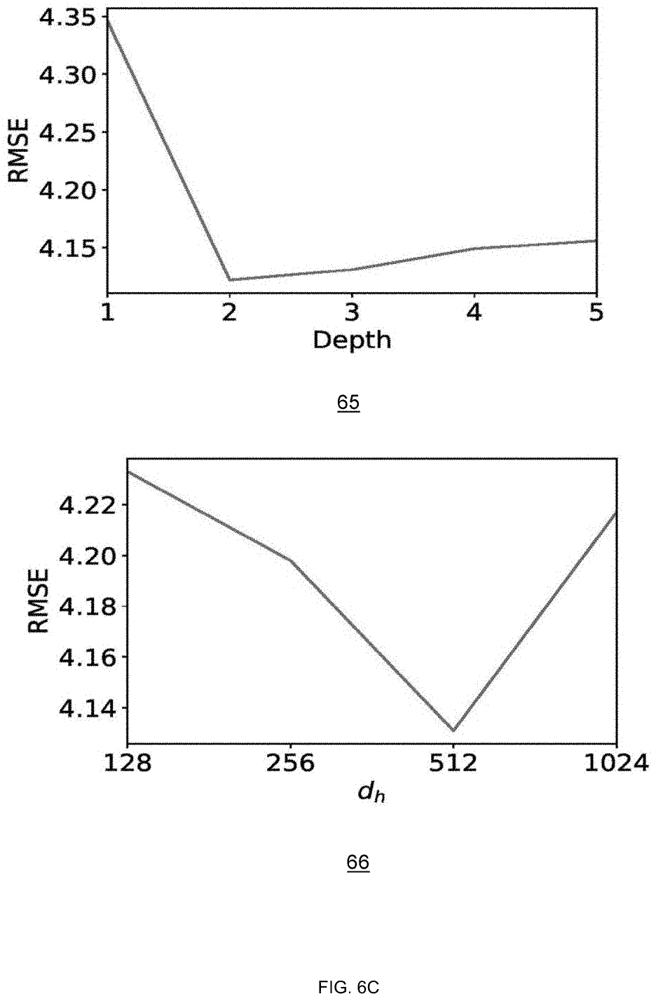

FIGS. 6A, 6B and 6C include graphs 61-66, whereas graphs 61-63 illustrate sensitivity to dₙ and graphs 64-66 illustrate sensitivity to tree depts—for all three datasets.

FIGS. 6A, 6B and 6C show the effect on the RMSE score when varying either one of these. As can be seen, the solution is largely insensitive to its parameters.

The parameters presented in the main text are not optimal: gains in accuracy can be achieved, in some cases, by considering deeper or shallower trees or by enlarging the embedding.

Robustness to Perturbations of the Training Set It can be expected that a model that transfers knowledge between different users would be more robust to perturbations of the training set of a new user than a model that is learned from scratch. In addition, the mean pooling that is performed to compute the training set embedding r=[1/n]Σᵢ₌₁ⁿ rᵢ averages all samples together, which also indicates robustness.

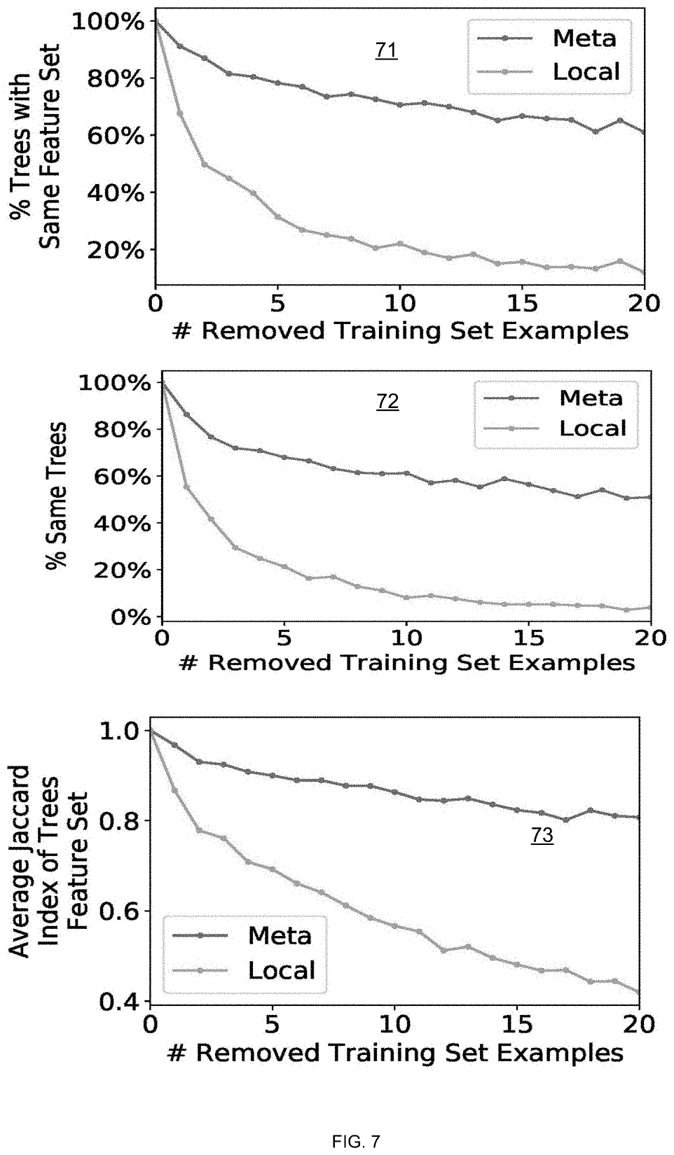

The robustness to perturbations of the training set is shown in FIG. 7, illustrating a comparison between the solution to a local model on the MovieLens 100K dataset. The plots show the behavior more and more samples are removed from the training set, averaging over 10 random subsamples of the training set.

A first measure of the obtained tree after removing samples is identical to the original tree in the features along the nodes and in the order in which they appear. The solution was further tested by performing a more liberal test, which compares the sets of features regardless of the node order and multiplicity of each feature. For the sets of features both the percent of cases in which the two sets (obtained from the full training set and the sampled one) are identical, as well as the Jaccard index are provided.

As can be seen, the proposed solution generates a user specific decision tree that is far more robust than the local tree model.

FIG. 7 illustrates an example of measuring the robustness of the user specific decision tree generated by the solution (“Meta”) and the local-trees (“Local”) baseline. Comparing the trees generated using the original user's training set and after removing a random subset from it. Graph 71 illustrates numbers of same trees versus a number of removed training set examples. Graph 72 illustrates number of trees with same feature set versus a number of removed training set examples. Graph 73 illustrates an averaged Jaccard index of the set of features used versus a number of removed training set examples.

Cold Start: Behavior for a Small User Training Set

As an example of the ability to gain insight from interpretable models, the model behavior was studied with respect to the size of the user training set.

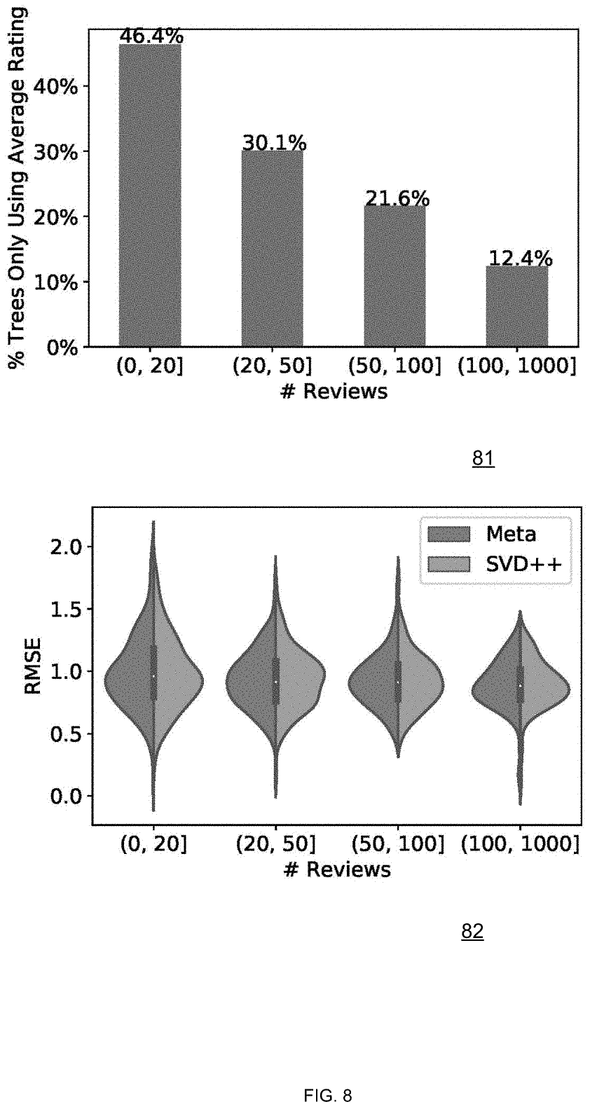

FIG. 8 illustrates a performance comparison of the meta-tree algorithm (“Meta”) and SVD++ for different per-user training set size. FIG. 8 illustrates that the solution is performing similarly to SVD++ across all bins of the training set size for test users.

Graph 81 of FIG. 8 especially illustrates a percentage of trees using only the item average rating as a function of the user's training set size.

Graph 82 of FIG. 8 illustrates that the solution tends to produce more trees using only the item average rating for users with small training sets. This observation makes sense as for such users it is harder to have high certainty regarding the users' preferences hence using the population consensus (with adjustments) is a reasonable option.

Odd Users: The Case of Contrarian Ratings

Inspecting the trees generated by the solution, the inventors encountered an unexpected type of trees generated across all three datasets. These trees are called “Reverse trees”, and their logic indicates that the users represented by them tend to prefer items which other users rate with low scores. This logic is in contrast to the item bias term in CF algorithms, which is used to reduce the item average ratings from each rating.

In order to test whether the data supports this model behavior, a comparison was made of the user specific decision tree performance to that of the SVD++ algorithm with respect to the correlation between the user's ratings and average item ratings.

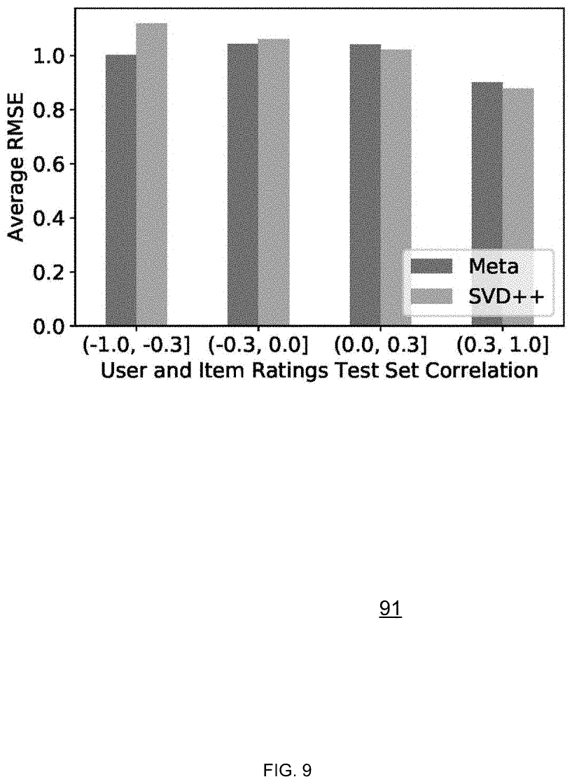

FIG. 9 includes graph 91 that illustrates a comparison of the meta-tree model (“Meta”) and the SVD++ algorithm performances on the MovieLens-100 k dataset with respect to the users' ratings correlation with the average item rating.

FIG. 9 shows that the user specific decision tree indeed outperforms SVD++ for users with negative correlation and that the performance of SVD++ improves as the correlation increases, this phenomena was, unknown and is a demonstration of the advantages of having such an interpretable model at hand.

Ablation Analysis

Table 2 is an example of an ablation analysis testing various variants of our the solution (RMSE).

To evaluate the various contributions, the following variants of the solution were evaluated:
1. Test on trees without applying the sparsification operator R first.
2. Removing the sparsification term (Equation 6) from the training loss.
3. Using mean value in the leaves instead of g.
4. Removing the first input r from f and g.
5. Training with a fixed β=1.
6. Setting β=1 but allowing w to get negative values.
7. One-hot w in training, using straight-through (ST) estimators
8. Employing hard routing and ST estimators when computing loss.
9. Measuring the loss also on the train samples in Lₖ.

TABLE 2

| | M.Lens 100 | | Jester | | | M.Lens 100 | | Jester | |
|---|---|---|---|---|---|---|---|---|---|
| (lr)2-3 (lr)4-5 | Soft | Hard | Soft | Hard | Method/Routing | Soft | Hard | Soft | Hard |
| (lr)7-8 (lr)9-10 | | | | | | | | | |
| Method/Routing | | | | | | | | | |
| (lr)1-5 (lr)6-10 | | | | | | | | | |
| Meta Trees | 0.947 | 0.970 | 4.001 | 4.131 | Without β | 0.950 | 1.317 | 4.022 | 5.118 |
| (sparse) | | | | | | | | | |
| Semi-sparse | 0.948 | 0.974 | 4.035 | 4.131 | W/o β, | 0.953 | 0.999 | 4.064 | 5.946 |
| | | | | | allowing w < 0 | | | | |
| No sparse norm | 0.953 | 0.988 | 4.024 | 4.190 | 1-hot weights | 0.958 | 1.024 | 4.035 | 4.277 |
| | | | | | in train | | | | |
| Mean leafs(no g) | 1.019 | 1.063 | 4.209 | 4.372 | Hard routing | 0.969 | 0.973 | 4.050 | 4.077 |
| | | | | | in loss | | | | |
| g, f only using r_{I} | 0.952 | 0.984 | 4.083 | 4.243 | Using train | 0.951 | 0.982 | 4.056 | 4.200 |
| | | | | | for loss | | | | |

As Table 2 shows, all of these modifications seem detrimental to the loss.

For example, when working with trees where the sparsification operator R was not applied, the results for hard routing deteriorate slightly. Using a fixed beta significantly harms the hard routing performance, and removing regression function g results in poor performances for both soft and hard. The only exception is variant 8, which could help improve results for hard routing at inference.

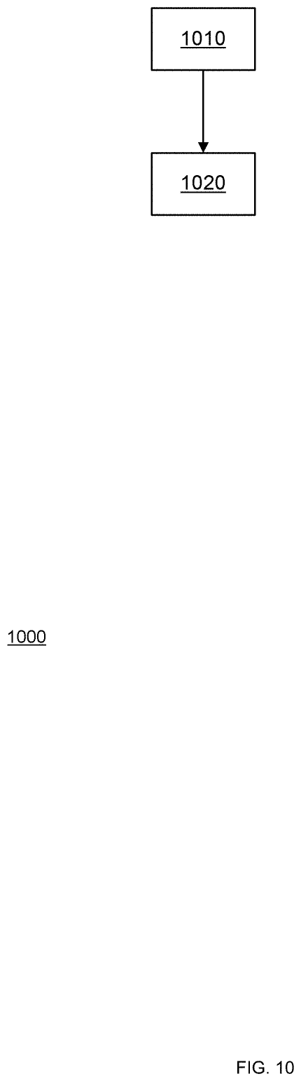

FIG. 10 illustrates method 1000 according to an embodiment of the invention.

Method 1000 may be for generating a group specific decision tree that is associated with a group of at least one user, out of multiple groups of at least one user.

Method 1000 start by step 1010 of learning regression functions and an embedding function using information related to other groups of the multiple groups.

Step 1010 may be followed by step 1020 of applying the embedding function and the regression functions on information related to the group to provide the group specific decision tree

Step 1020 may include applying the first regression function to determine decisions rules associated with the root node and to inner nodes of the group specific decision tree.

Step 1020 may include applying the second regression function to determine values of leaves of the group specific decision tree.

An example of the execution of step 1020 is provided below—it is assumed that the information related to the group are decisions made by one or more members of the group in relation to a certain type of query.

It is assumed that there are ten previous decisions (Y1-Y10). The ten decisions are made in relation to ten items (X1-X10)—each item may be represented by a feature vector. The pairs of decision and item are denoted D1-D10.

Step 1020 may include applying an embedding function h on D1-D10 to provide a first set of embedded samples r_{I1}. The first regression function f is applied on r_{I1} to provide w₁, b₁, and β₁.

D1-D10 are collectively denoted I₁.

The root decision includes checking if w₁^{T}x<b₁—if so go to the left—else—go to the right. This is an example of a hard rule. A soft rule would assign a probability to each case (go right or go left).

When applying the root decision—in case of D1-D6 go to the left (second node) and in case of D7-D0 go to the right (third node).

D1-D6 are collectively denoted I₂.

D7-D10 are collectively denoted I₃.

Applying embedding function h on D1-D6 to provide a second set of embedded samples r_{I2}. The first regression function f is applied on r_{I2} to provide w₂, b₂, and β₂.

Applying embedding function h on D7-D10 to provide a third set of embedded samples r_{I3}. The first regression function f is applied on r_{I3} to provide w₃, b₃, and β₃.

The second node decision includes checking if w₂^{T}x<b₂—if so go to the left—else—go to the right.

When applying the second node decision—D1 and D2 go to the left (fourth node) and D3-D6 go to the right (fifth node).
D1 and D2 are collectively denoted I₄.
D3-D6 are collectively denoted I₅.
The third node decision includes checking if w₃^{T}x<b₃—if so go to the left—else—go to the right.
When applying the third node decision—D6 goes to the left (sixth node) and D8-D10 go to the right (fifth node).
D7 is also denoted I₆.
D8-D10 are collectively denoted I₇.

The fourth, fifth, sixth and seven nodes are leaves—and their values are calculated by applying the embedding function and the second regression function on I₄, I₅, I₆, and I₇.

The learning of the embedding function and the regression functions may include using a loss function that takes into account at least one of the sparsity loss and the regression loss.

Taking into account the sparsity loss induces the decisions to be sparse.

The one or more decisions of the user specific decision tree may be one or more hard rules (such as illustrated in FIG. 2B).

The one or more decisions of the user specific decision tree are one or more soft rules. In this case, a decision of a node does may determine the next node by assigning probabilities to the selection of the next inner node or leaf.

Each of the one or more decisions of the user specific decision tree may be a function of a first parameter (b), a probabilistic parameter (β) and a pseudo probability vector (w).

The each of the one or more decisions of the user specific decision tree is a function of a first parameter (bᵢ), a probabilistic parameter (βᵢ) and a sparse vector (wᵢ).

The one or more decisions of the user specific decision tree may be one or more human perceivable expressions—such as textual expressions, mathematical expressions, and the like.

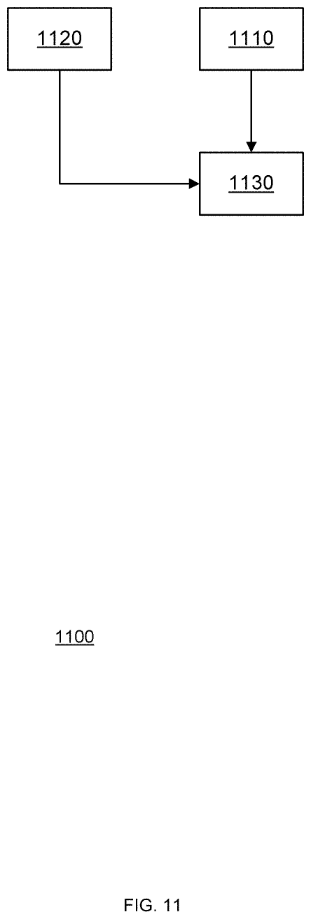

FIG. 11 illustrates method 1100 according to an embodiment of the invention.

Method 1100 may be for generating a decision tree based response to a query that is related to a group of at least one user out of multiple groups of at least one users.

Method 1100 may include step 1110 of obtaining the query.

Method 1100 may include step 1120 receiving or generating a group specific decision tree. The group specific decision tree is associated with the group and is generated by applying an embedding function and regression functions on group related information. The embedding function and the regression functions are learnt using information related to other groups of the multiple groups.

The rules of the decision nodes of the a group specific decision tree are explainable—they are human perceivable—for example may be mathematical expressions or text that explain the decisions.

The group specific decision tree may be a soft tree (includes soft decisions) or a hard tree (includes hard rules). A soft rule may include assigning a probability to each outcome of the decision.

The generating may include executing method 1000.

Steps 1110 and 1120 may be followed by step 1130 of generating the decision tree based response. The generating of the decision tree based response may include applying one or more decisions of a group specific decision tree. The applying may include traversing one or more decision nodes of the group specific decision tree.

The decision tree based response may be a recommendation, a command, or any other type of response.

The regression functions may include a first regression function (f) and a second regression function (g). There may me more than two regression functions.

The first regression function once applied determines decisions rules associated with inner nodes of the group specific decision tree.

The second regression function once applied determines values of leaves of the group specific decision tree.

At least one of function of the embedding function and the regression functions may be learnt using a loss function that considers a sparsity loss.

At least one node of the group specific decision tree may be a function of a first parameter (b), a probabilistic parameter (β) and a pseudo probability vector (w).

At least one node of the group specific decision tree may be a function of a first parameter (b), a probabilistic parameter (β) and a sparse vector (w).

Any one of the steps and/or methods and/or algorithms illustrated int he specification and/or drawings and/or claims may be executed by a computerized entity such as a system and/or computerized unit.

The computerized entity may include a processor, a memory unit and an input/output unit. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

### EXPERIMENTS

A Synthetic Classification Problem

The solution was tested on a synthetic binary classification problem. The ground truth labels are obtained from a decision tree of depth two, where each node is a decision stump. Each set of samples L in the experiment consists of random d-dimensional vectors, and the set's ground truth decision tree is constructed by drawing three random indices {i₁, i₂, i₃}⊂[d] from a skewed distribution defined as p(i)=[(sⁱ)/(sim (for i between 1 and d)sⁱ)], where s controls the skewness. Finally, the set's labels are determined as y=((xᵢ₁>0)∧(xᵢ₂>0))∨((xᵢ₁≤0)∧(xᵢ₃>0)). A separate set unseen during training, classified by the same decision rule, is used for evaluation. In the experiments, d=10 and s=1.3. In the training set, the number of samples in each set L is sampled uniformly U(1,50).

Test three types of trees were tested: (i) full trees of depth two, (ii) full trees of depth three, and (iii) trees that are grown according to the stopping criterion, up to maximum depth of five. In order to train the meta trees for this classification problem, the squared loss in Equation 5 was replaced with the logistic loss. For all three models dₕ=512 (which seems optimal for the three models) and the loss is minimized by the Adam optimizer with a learning rate of 3·10⁻⁴, batch size 256.

Sparse meta trees were compared with hard decisions (each sample is associated with a single leaf) to two types of vanilla decision trees, of depths two or three: (i) Local Trees—a decision tree fitted on the current set L of training samples, and (ii) Global Tree—a decision tree fitted on the union of the training samples from all training sets, with the addition of the set L. Both trees employ decision stumps and are trained by the CART algorithm by implementation in scikit-learn.

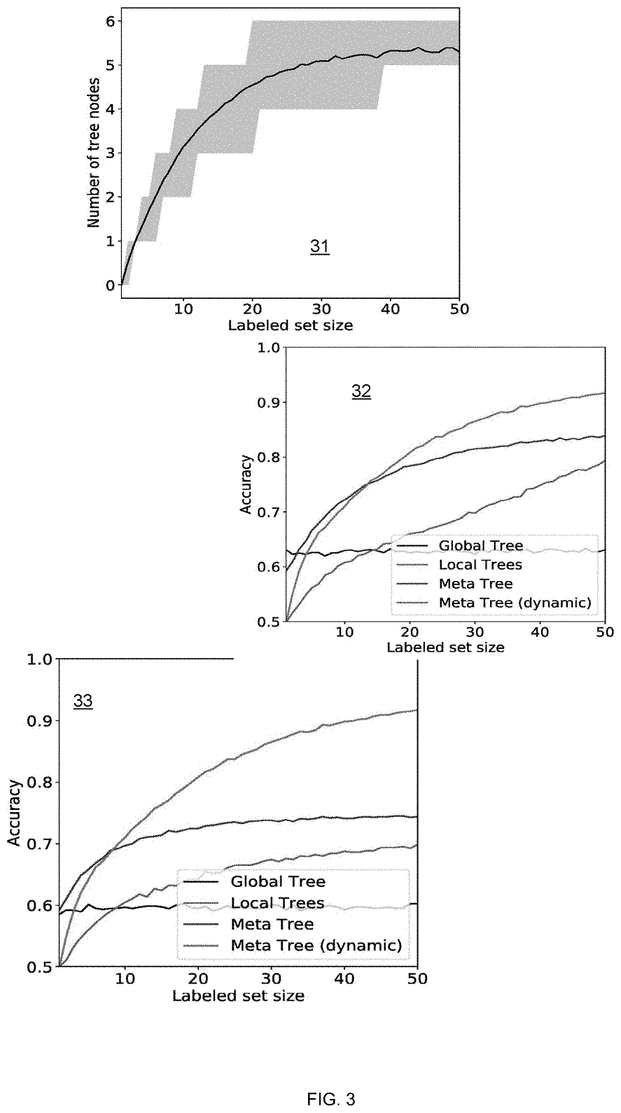

FIG. 3 includes three graphs 31, 32 and 33 that illustrate results related to the Synthetic problem. Graphs 31 and 32 illustrate the performance as a function of the labeled set size (|L′|). The depth of all models, except for the dynamic meta tree, is 2 in graph 31 and 3 in graph 32. Graph 33 illustrates an average and 25th/75th percentiles of inner node count in dynamic trees.

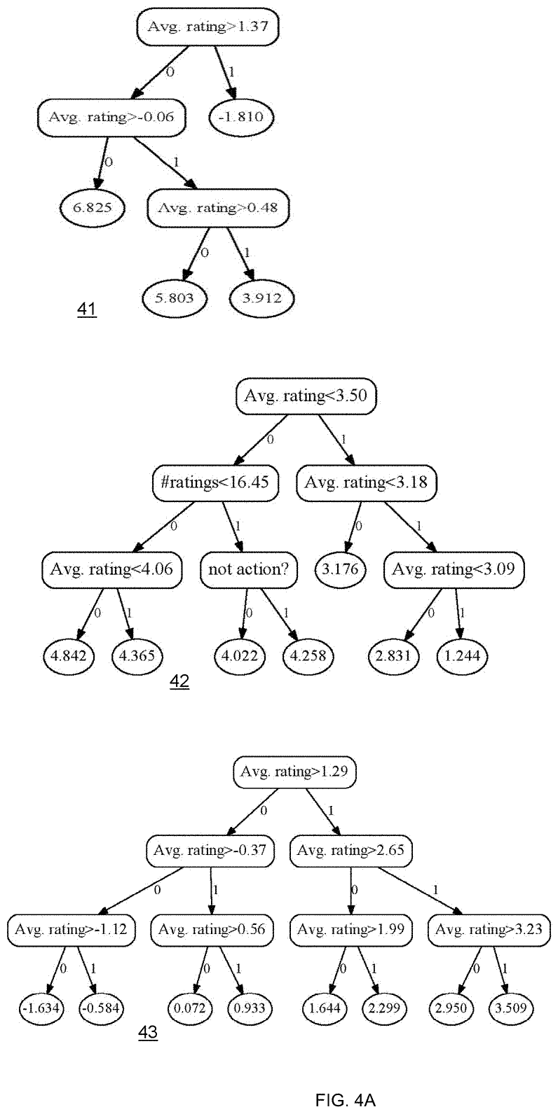

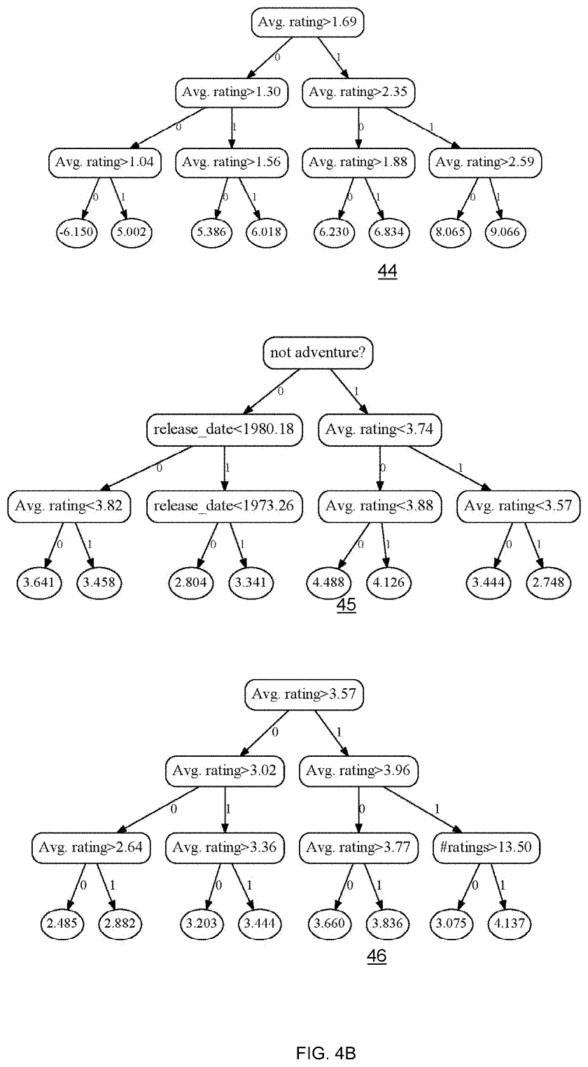

FIGS. 4A, 4B and 4C illustrate six examples of tree denoted 41-46. Note that the dynamic meta-tree is the same experiment in both panels. The results show that the vanilla trees are outperformed by the fixed-depth meta-tree as well as by the dynamic architecture meta tree. As expected, the accuracy of all meta trees models, as well as that of the local trees, increases as more training samples are presented. The results indicate that the dynamic tree outperforms the fixed trees when more training samples are present. Additionally, while the fixed trees of depth three use exactly seven inner nodes, the dynamic trees tend to employ less. The average number of nodes, as well as the 25th and 75th percentiles, are shown in graph 43.

Recommendations Datasets

To test the solution, three popular recommendations datasets were tested—and include MovieLens 100K, MovieLens 1M and Jester.

The MovieLens datasets consist of integer movie ratings from 1 to 5 and include the movie metadata, such as the movie genres and its release year. The user specific decision trees are based on this meta data with the addition of the average rating for each movie and the number of times it was rated, both computed on the entire training set.

The MovieLens 100K dataset contains 100,000 ratings of 943 users for 1680 different movies, and the MovieLens 1M dataset contains 1 million ratings of 6,040 users for 3,706 different movies.

The Jester dataset is of continuous jokes ratings from −10 to 10, containing the jokes' texts.

Several features from the jokes texts were extracted, such as the number of lines in the joke, the number of all tokens, and the number of occurrences of each of the 50 most common non-stop tokens in the dataset. The dataset contains users with very few ratings, after removing all users with less than 20 ratings, it contains approximately 1.4 million ratings of 26,151 different users for 140 different jokes.

For the MovieLens 100 k dataset, the canonical ul.base/ul.test split was used. For MovieLens-1M and Jester, 10% of the data was randomly selected for the test set.

TABLE 1
Performance comparison on the MovieLens
100k, MovieLens 1M and Jester datasets.

| | MovieLens | | MovieLens | | | |
|---|---|---|---|---|---|---|
| | 100K | | 1M | | Jester | |
| (lr)2-3 (lr)4-5 (lr)6-7 | RMSE | MAE | RMSE | MAE | RMSE | MAE |
| Global Tree (best | 0.995 | 0.778 | 0.935 | 0.738 | 4.302 | 3.136 |
| depth) | | | | | | |
| Local Trees (best | 1.018 | 0.791 | 0.947 | 0.737 | 4.556 | 3.137 |
| depth) | | | | | | |
| KNN Trees (best k) | 0.975 | 0.770 | 0.921 | 0.726 | 4.161 | 3.070 |
| Gradient boosted | 0.976 | 0.771 | 0.933 | 0.736 | 4.119 | 3.131 |
| regression trees | | | | | | |
| SVD | 0.953 | 0.751 | 0.868 | 0.682 | 4.073 | 2.987 |
| SVD++ | 0.932 | 0.730 | 0.861 | 0.671 | 4.198 | 3.146 |
| GRALS | 0.945 | — | — | — | — | — |
| sRGCNN | 0.929 | — | — | — | — | — |
| Factorized EAE | 0.920 | — | 0.860 | — | — | — |
| GC-MC | 0.905 | — | 0.832 | — | — | — |
| Meta Trees (sparse, | 0.947 | 0.747 | 0.876 | 0.687 | 4.001 | 3.012 |
| soft) | | | | | | |
| Meta Trees (sparse, | 0.970 | 0.766 | 0.916 | 0.722 | 4.131 | 3.030 |
| hard) | | | | | | |
| Dynamic Meta Trees | 0.948 | 0.747 | 0.872 | 0.683 | 4.008 | 3.062 |
| (sparse, soft) | | | | | | |
| Dynamic Meta Trees | 0.975 | 0.767 | 0.914 | 0.720 | 4.171 | 3.097 |
| (sparse, hard) | | | | | | |

The performance of the solution were compared to acceptable literature baselines, which include: SVD and SVD++ which are popular collaborative filtering methods implemented in the Python Scikit Surprise package, various tree baselines, and the state of the art methods for both MovieLens benchmarks. From these methods, only the tree results are explainable.

The tree baselines include the Global- and Local-Tree models described in the synthetic problem section. When presenting the results of these global and local trees, hyperparameters were selected and demonstrate the best test performance. This is done in order to set an upper bound on their performance.

For global (local) trees, a maximum tree depth of three, four and three (one, two and one) were used for the MovieLens 100K, MovieLens 1M and Jester respectively.

An additional baseline, called kNN trees is added, in which the training set is augmented by the training set of the k nearest users. User similarity is determined according to the cosine distance of the user embedding vectors generated by the SVD++ method.

This way, the data of the user was augmented, which is limited by nature, by the data of similar users, mitigating the risk of overfitting and potentially obtaining a more accurate tree.

The performance shown is for the best possible k as evaluated on the test set, see appendix for a graph depicting the performance as a function of k.

While less interpretable than the other tree-based baselines, we also add the performance of gradient boosted regression trees, using the scikit-learn implementation.

For all benchmarks, a tree depth of three was used for the fixed architecture meta trees, and for both the dynamic and fixed architectures dₕ=512 and λ=0.1 were used. This set of parameters was set early on in the development process and kept for all future experiments.

The models are compared in terms of the acceptable evaluation metrics: root-mean-square-error (RMSE) and mean-absolute-error (MAE).

The results of the experiment are shown in Table 1.

From the results it can be seen that for both MovieLens datasets the model outperforms the trees benchmarks and achieves comparable performances to those of the SVD algorithm, but often falls slightly behind the latest unexplainable methods.

On the Jester dataset, for which most of the recent literature methods do not report results, the solution outperforms all baseline methods. In addition, the solution is robust to small modifications of the training set, see appendix.

White-box models support introspection. In all three datasets the following types of trees were found:
(i) Feature specific trees: For most users, the model builds trees which use specific features. The users depicted in FIGS. 4C and 4E are generally aligned with the average rating. However, the first dislikes adventure movies and the second tends to trust the average rating when the movies were frequently rated.
(ii) Classic CF trees: This type of tree splits the examples by their average rating and adjusts the leaf values to the specific user ratings. The model produces such trees mostly for users with a small number of ratings, see appendix. This behavior is very similar to that of a baseline CF algorithm where the predicted user rating is the sum of the dataset average rating, the item bias, and the user bias. An example for such a tree built for a Jester user with very high ratings is shown in FIG. 4D.
(iii) Reverse trees: this type of tree is built for users which prefer “bad” movies/jokes, i.e. they rate highly items with low average ratings. The trees the model builds for such users are very similar to classic CF trees in terms of splitting the examples. The difference is that the leaf values appear in reverse order, adjusted to the specific user ratings. FIG. 4F shows an example for such a tree.

Any reference to the term “comprising” or “having” should be interpreted also as referring to “consisting” of “essentially consisting of”. For example—a method that comprises certain steps can include additional steps, can be limited to the certain steps or may include additional steps that do not materially affect the basic and novel characteristics of the method—respectively.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a computer program product such as non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc. A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input and responds by allocating and managing tasks and internal system resources as a service to users and programs of the system. The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A method for generating a decision tree based response to a query that is related to a group of at least one user out of multiple groups of at least one users, the method comprises:
obtaining the query; and
generating the decision tree based response, wherein the generating of the decision tree based response comprises applying one or more decisions of a group specific decision tree, wherein the group specific decision tree is associated with the group and is generated by applying an embedding function and regression functions on group related information, wherein the embedding function and the regression functions are learnt using information related to other groups of the multiple groups.

2. The method according to claim 1 wherein nodes of the group specific decision tree are represented by mathematical expressions.

3. The method according to claim 1 wherein the regression functions comprise a first regression function and a second regression function.

4. The method according to claim 3 wherein the first regression function once applied determines decisions rules associated with inner nodes of the group specific decision tree.

5. The method according to claim 3 wherein the second regression function once applied determines values of leaves of the group specific decision tree.

6. The method according to claim 1 wherein the embedding function and the regression functions are learnt using a loss function that considers a sparsity loss.

7. The method according to claim 1 wherein at least one function out of the embedding function and the regression functions are learnt using a loss function that considers a sparsity loss.

8. The method according to claim 1 wherein the group specific decision tree is a hard tree.

9. The method according to claim 1 wherein the group specific decision tree is a soft tree.

10. The method according to claim 1 wherein each node of the group specific decision tree is a function of a first parameter, a probabilistic parameter and a pseudo probability vector.

11. The method according to claim 1 wherein each node of the group specific decision tree is a function of a first parameter, a probabilistic parameter and a sparse vector.

12. The method according to claim 1 wherein the decision tree based response is a recommendation.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. A non-transitory computer readable medium for generating a decision tree based response to a query that is related to a group of at least one user out of multiple groups of at least one users, the non-transitory computer readable medium stores instructions for:
obtaining the query; and
generating the decision tree based response, wherein the generating of the decision tree based response comprises applying one or more decisions of a group specific decision tree, wherein the group specific decision tree is associated with the group and is generated by applying an embedding function and regression functions on group related information, wherein the embedding function and the regression functions are learnt using information related to other groups of the multiple groups.

25. The non-transitory computer readable medium according to claim 24 wherein nodes of the group specific decision tree are represented by mathematical expressions.

26. The non-transitory computer readable medium according to claim 24 wherein the regression functions comprise a first regression function and a second regression function.

27. The non-transitory computer readable medium according to claim 26 wherein the first regression function once applied determines decisions rules associated with inner nodes of the group specific decision tree.

28. The non-transitory computer readable medium according to claim 26 wherein the second regression function once applied determines values of leaves of the group specific decision tree.

29. The non-transitory computer readable medium according to claim 24 wherein the embedding function and the regression functions are learnt using a loss function that considers a sparsity loss.

30. The non-transitory computer readable medium according to claim 24 wherein at least one function out of the embedding function and the regression functions are learnt using a loss function that considers a sparsity loss.

31. The non-transitory computer readable medium according to claim 24 wherein the group specific decision tree is a hard tree.

32. The non-transitory computer readable medium according to claim 24 wherein the group specific decision tree is a soft tree.

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)
